(19) United States
(12) Patent Application Publication
(10) Pub. No.: US 2008/0173158 A1
(43) Pub. Date: Jul. 24, 2008

(54) Drum shell with incorporated lugs

(76) Inventor: Larry C. Lee, San Diego, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/654,935

(22) Filed: Jan. 18, 2007

(51) Int. Cl. G10D 13/02

(52) U.S. Cl. 84/421

(57) ABSTRACT

The present invention is directed to a laminated decorative wood drum shell with incorporated lugs having a smooth central cavity and the unique laminating process involved in the fabrication. A variety of hardwoods in varying colors and thickness will be use to construct the drum shell. Conventional threaded inserts will be inserted into the top and bottom of the lugs providing an attachment means for the top and bottom drum hoops or rims eliminating other attachment hardware while reducing the overall weight of the completed drum yet increasing both the structural integrity and durability, and enhancing the overall tonal quality of the drum. The top drumhead skin can be tightened separately from the bottom allowing for separate tuning of the heads.

### FIELD OF THE INVENTION

The present device relates to the field of the design of the drum cylindrical body commonly called a drum shell, used for example on a bass drum, a snare drum or marching drum. More particularly to the design, unique decorative features and the manufacturing processes used to construct the cylindrical laminated wood body of the drum shell incorporating the lugs.

### BACKGROUND OF THE INVENTION

The conventional musical drum generally consists of two head diaphragms or skins on a cylindrical body designated as the drum shell. This construction allows the vibration of one head diaphragm to be transferred through the air inside the drum shell to the other head diaphragm causing the other head to also vibrate. The drumheads or skin, are held in place over the end of the drum shell by drum hoops or rims. A plurality of tensioning screws pass through apertures in each rim and are screwed into fixed brackets, which are normally mounted at uniformly spaced positions around the drum shell. This direct physical attachment of the brackets and hardware into or through the shell serves to dampen resonance of the drum. Tuning of the drum is normally accomplished by tightening the screws into the bracket. This operation serves to draw the drum rim down over the end of the drum shell, thereby applying tension on the drum skin, which is stretched over the edge of the drum shell.

In most conventional drums, the drum rims, which hold the drumheads in place, are connected to the drum shell by direct physical attachment, via metal hardware, allowing the drumheads to be tightened down separately. This attachment generally involves drilling holes into the shell at numerous points for the attachment hardware. The main source of sound from a conventional drum is the vibration of the drumhead which is a result of being struck by a drumstick, hand or other objects, inducing multiple vibrations in the diametrically opposed drumheads. A major portion of the weight of the drums is in the hardware required to tighten down the drumheads.

A further problem associated with this type of construction is that the mechanical strength of the drum shell is weakened and the shell tends to become damaged under excess tension normally applied to the military and pipe band drums, which is in the order of 80 to 100 psi.

Numerous innovations for drum shells have been provided in the prior art that is described as follows. Even though these innovations may be suitable for the specific individual purposes to which they address, they differ from the present invention as hereinafter contrasted. The following is a summary of those prior art patents most relevant to the invention at hand, as well a description outlining the difference between the features of the present invention and those of the prior art.

U.S. Pat. No. 4,714,002 of Terry P. Cleland describes a pair of concentric ring hoops that overlap each other and hold the perimeter edge of a drumhead vibratile element in tension between the mating overlapping faces of the hoops. The hoops are held together by a tensioning bolt threadable into a bracket connected to a lower hoop which has another skin stretched between a stepped inner annular groove on its inner face edge. A drum shell made of a composite of rigid foam interior spaced apart by a pair of epoxy impregnated carbon fibre sheets is held by the lower second drum skin into enclosing engagement on its upper perimeter edge with an inner stop flange and vertical wall face of the inner hoop ring of the drum head vibratile skin assembly.

This patent describes a pair of concentric rings used to tighten down the drum skin. This patent allows no penetration of the drum shell but puts compressive pressure on the drum shell edges as a tightening means. Although the hardware of this device does not penetrate the surface of the drum shell, it is constructed of a foam core polymer laminate, which does not have the unique features and desired appearance of the laminated hardwoods. The use of decorative wood structures for musical instruments has always been a desirable feature.

U.S. Pat. No. 4,869,146 of Clive W. L. Bonsor discloses a musical drum having an outer cage to which both top and bottom counter hoops are connected in an independently adjustable manner. An intermediate hoop is provided between the top and bottom counter hoops to which a plurality of adjusting bolt assemblies for the top and bottom counter hoops are connected. The adjusting bolt assemblies for the bottom counter hoop are circumferentially offset with respect to the adjusting bolt assembles for the top counter hoop.

This patent describes another drum where they have gone to a great deal of trouble to not penetrate the surface of the drum shell, but rely on external hardware to accomplish this task. This patent discloses a unique tensioning mechanism. It is not directed at the structure of the drum shell and could not be constructed by the same unique laminating process used in the fabrication of the proposed drum shell with incorporated lugs.

U.S. Pat. No. 5,447,087 of Paul A. Hawes et al. tells of a drum head tensioning mechanism of or for a musical drum, an intermediate hoop assembly or cage is secured about the drum shell by end abutment therewith and supports top and bottom drum heads, top and bottom counter hoops are provided about the drumheads and respectively engage flush hoops on the drumheads. Upper and lower tensioning bolt assemblies connect the counter hoops to the intermediate hoop assembly, the lower bolt assemblies extending upwardly towards and interspaced with the upper bolt assemblies whereby all the bolt assemblies are accessible for conveniently and independently adjusting both top and bottom drum head tension. The interior of the drum shell also remains “clean” for optimum sound quality.

This patent describes another style of tensioning mechanism and not the design or the structure of the drum shell.

U.S. Pat. No. 6,417,432 of Michael J. Downing describes a musical drum, which utilizes a principle of physics to achieve an unequal tensioning of the upper head and the lower head without the need of physical attachments or piercing of the drum shell. The shell of the drum remains suspended by shell's bearing edge, in contact only with the upper and lower heads and respectively. This allows the shell of the drum to resonate freely and unencumbered by any attachments of hardware.

This patent describes a free-floating drum shell with no attachments to the external hardware. This design offers a smooth inner surface to the drum shell but still requires an excessive amount of external hardware increasing the weight of the drum assembly.

U.S. Pat. No. 6,686,527 of Takashi Hagiwara of describes a drum tightening frame having bolt attachment openings disposed in a circular plate portion of the tightening frame, the bolt attachment openings being arc-shaped slots closed at both ends, and each of these openings comprising a primary opening section through which the shank (and not the head) of a corresponding tightening bolt is passed and a secondary opening section which communicates with one end of the primary opening section and has a size that allows the head of the tightening bolt to pass through. In addition, when washers are used, the tightening frame, tightening bolts and washers can be formed so as to be magnetically attracted to each other so that the washers can stay with the tightening frame or with the tightening bolts, thus avoiding the washers from being lost when the tightening bolts are removed from the drum body.

This patent describes a drumhead-tightening frame having a bolt attachment to the drum shell, which displays a similarity to the most conventional method of manufacturing drums.

None of the foregoing prior art teaches or suggests the particular unique features of the drum shell with incorporated lugs and thus clarifies the need for further improvements in the design and manufacturing processes of the drum shells used on a variety of drums in the music industry,

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### SUMMARY OF THE INVENTION

The principal advantage of the drum shell with incorporated lugs is to create a decorative wooden drum with a smooth unobstructed central cavity.

Another advantage of the drum shell with incorporated lugs is to be able to tighten or tune the top and bottom drumheads diaphragms separately.

Another advantage of the design of the drum shell with incorporated lugs is being able to fabricate it by laminating a variety of different hardwoods of varying colors.

Another advantage of the design of the drum shell with incorporated lugs is being able to construct a unique decorative laminated wood frame where the lugs are strong enough to withstand the forces required when tightening the separate drumhead diaphragms.

Another advantage of the design of the drum shell with incorporated lugs is to have a minimum amount of external hardware.

Another advantage of the design of the drum shell with incorporated lugs is to reduce the weight of the complete drum assembly.

Another advantage of the design of the drum shell with incorporated lugs is being able to construct a decorative laminated wood frame, without wood ends exposed, thereby eliminating the grainy texture of said wood ends which is known to be more grainy and difficult to match-up with the rest of the wood grain.

Another advantage of the design of the drum shell with incorporated lugs is being able to construct a decorative laminated wood frame, without exposed wood ends, which improves and increases durability by preventing moisture build up.

Another advantage of the design of the drum shell with incorporated lugs is being able to construct a decorative laminated wood frame, without exposed wood ends, which enhances the overall tonal quality of the drum.

And still another advantage is to create an alternate embodiment of the drum shell with incorporated lugs having a similar decorative laminated wood appearance with the lugs attached by a tongue-and-groove means.

A further advantage is to create a drum with an enhanced quality of sound.

A final advantage of this drum shell with incorporated lugs is to add a new and unique instrument to the area of drums used in the music industry.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The present invention relates to a laminated decorative wood drum shell with incorporated lugs having a smooth central cavity. With the advent of the numerical control, machining capabilities and the new adhesives used, the unique shape required by the laminated decorative wood drum shell with incorporated lugs will be easily fabricated. Five laminate segments forming a pentagon are illustrated in the drawings but it must be understood at this time that the geometric shape of the laminate segments, or decorative design, is determined by the number of required lugs, or the desired decorative design. Each laminate layer will be rotated so that the seam between abutting segments falls on the center of every other lug and repeats on every other laminate layer. Each lug will have a seam in the center of every other layer of the laminate with joining laminate layers not having a seam in the center. A variety of hardwoods in varying colors and thickness will be used to construct the drum shell. A conventional threaded insert will be inserted into each side of the lugs providing an attachment means for the drum hoops or rims. The size and shape of the lugs of the drum shell may vary depending upon the size and shape of the desired drum and will still fall within the scope of this patent. The top and bottom rim of the drum shell will have the conventional beveled shape

With respect to the above description then, it is to be realized that the optimum dimensional relationships for the parts of the drum shell with incorporated lugs, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this drum shell with incorporated lugs.

FIG. 1 depicts a perspective view of the drum shell with incorporated lugs.

FIG. 2 depicts a cross section through the side of the drum shell with incorporated lugs and the hardware to tighten the top and bottom drumhead diaphragms or skins.

FIG. 3 depicts a plan view of the stacked laminate segments.

FIG. 4 depicts a side view of the drum shell with incorporated lugs.

FIG. 5 depicts a plan view of the drum shell with incorporated lugs.

FIG. 6 depicts a perspective view of the alternate embodiment of the drum shell with incorporated lugs using the tongue-and-groove means of attachment of the lugs.

FIG. 7 depicts a plan view of the alternate embodiment of the drum shell with incorporated lugs using the tongue-and-groove means of attachment of the lugs.

### DETAILED DESCRIPTION OF THE PREFERRED EMBODIMENTS

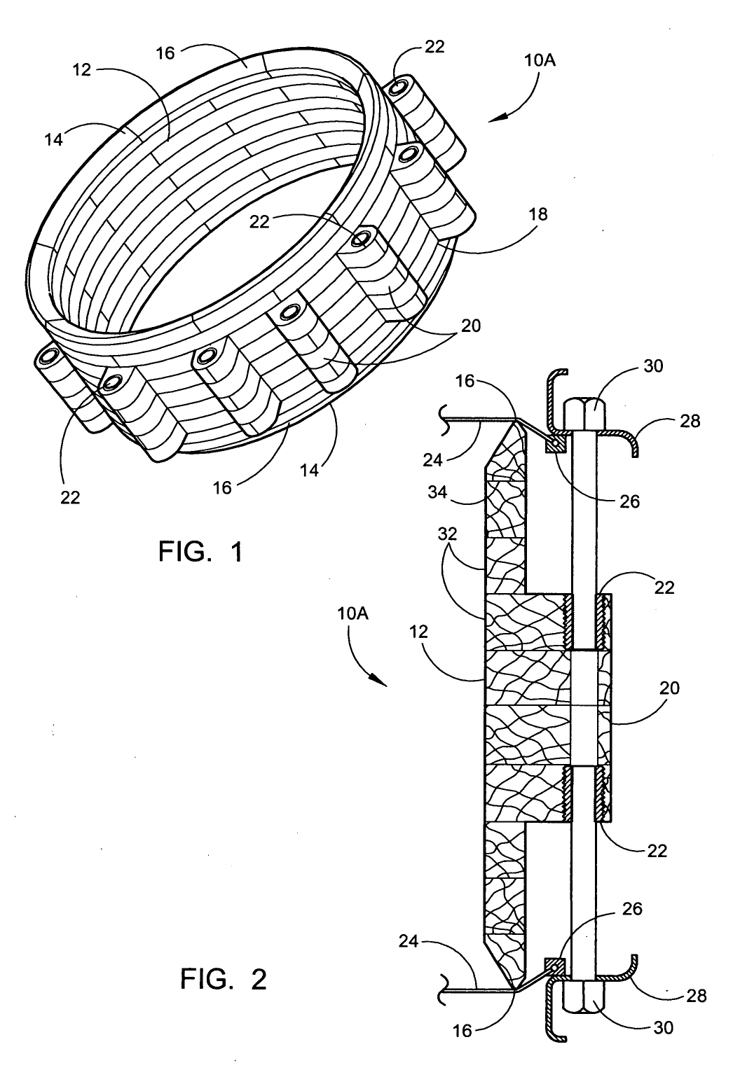

Referring now to the drawings, wherein similar parts of the drum shell with incorporated lugs 10A and 10B are identified by like reference numerals, there is seen in FIG. 1 a perspective view of the drum shell with incorporated lugs 10A illustrating the smooth cylindrical internal surface 12. The top and bottom edges 14 have the conventional tapered surface creating a bearing edge 16. The drum shell outer surface 18 incorporates a plurality of drum shell lugs 20 with threaded inserts 22 at each end.

FIG. 2 depicts a cross section through the side of the drum shell with incorporated lugs 10A and the drumhead diaphragms or skin 24 and skin stretched over the conventional bearing edge 16 to the skin-mounting ring 26. The drum hoop or rim 28 will press down evenly on the skin-mounting ring 26 when the tensioning screws 30 are tightened down in the threaded inserts 22 located in both ends of each of the drum shell lugs 20. The wood laminates 32 are shown in cross section with the adjoining wood surfaces 34 glued into position.

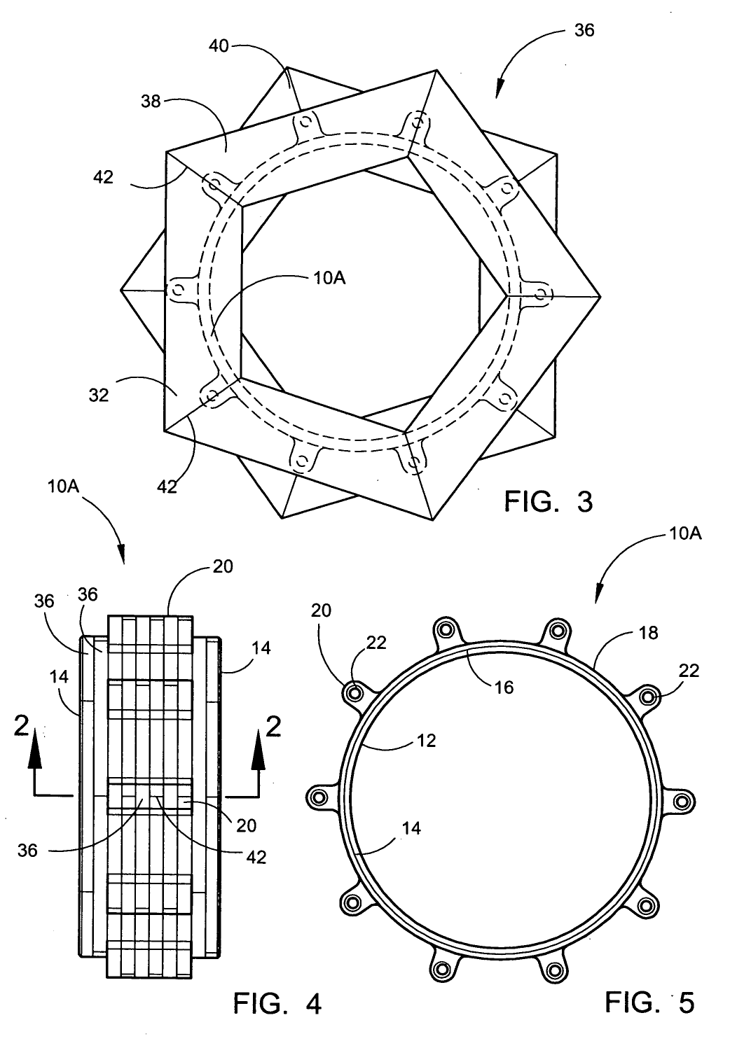

FIG. 3 depicts a plan view of the stacked laminate segments 36 in a pentagon configuration with the laminate top layer 38 consisting of five laminate segments 32. The laminate second layer 40 is rotated thirty-six degrees with each successive layer rotated in like manner. The finished machined drum shell 10A is shown in phantom. It must be emphasized that a variety of geometric configurations may be used depending on the number of drum shell lugs 20 required on the specific drum and still remain within the scope of this patent. The abutting laminate seams 42 bisect the center of every other lug 20 on each level of the stacked laminates 36 creating an extremely strong configuration.

FIG. 4 depicts a side view of the drum shell with incorporated lugs 10A illustrating the intermittent spacing of the laminate abutting seam 42 on the drum lugs 20. Ten layers of laminate segments 36 have been displayed for example, but the number of layers may vary depending on the height of the drum shell 10A required and the thickness of the laminate segments 36.

FIG. 5 depicts a plan view of the drum shell with incorporated lugs 10A having ten evenly spaced lugs 20. Each lug 20 will have a threaded insert 22 at the top and bottom. Said threaded inserts 22 are preferably metal and strong. It is contemplated that steel or brass inserts may be used.

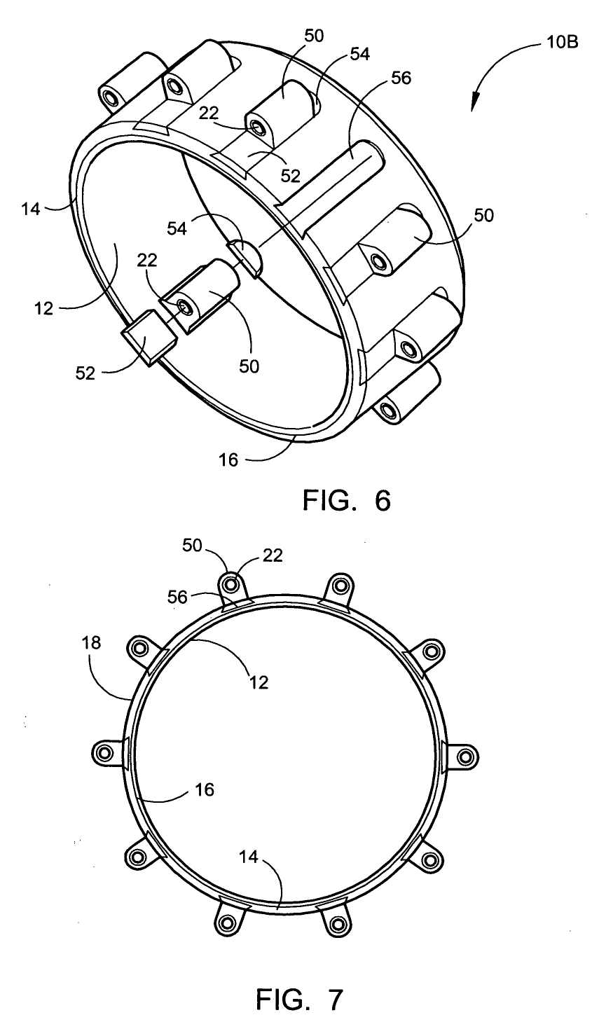

FIG. 6 depicts a perspective view of the alternate embodiment of the drum shell with incorporated lugs 10B using the tongue-and-groove means of attachment of the lugs 50. A single lug 50 is shown exploded away from the drum shell 10B illustrating a forward groove spacer 52, the lug 50 and the rear half-round groove spacer 54 in alignment with the routered groove 56 in the drum shell 10B. In this application, the lugs may be laminated wood, solid wood or made from a wide variety of polymer products. The drum shell 10B will be laminated radially in a conventional manner.

FIG. 7 depicts a plan view of the alternate embodiment of the drum shell with incorporated lugs 10B using the tongue-and-groove means of attachment of the lugs having ten evenly spaced lugs 20. Each lug 20 will have a threaded insert 22 at the top and bottom.

The drum shell with incorporated lugs 10A and 10B shown in the drawings and described in detail herein disclose arrangements of elements of particular construction and configuration for illustrating preferred embodiments of structure and method of fabrication of the present device. It is to be understood, however, that elements of different construction and configuration and other arrangements thereof, other than those illustrated and described may be employed for providing a drum shell with incorporated lugs 10A and 10B in accordance with the spirit of this invention. Such changes, alternations and modifications as would occur to those skilled in the art are considered to be within the scope of this device, as broadly defined within the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the drum shell with incorporated lugs of the application, which is measured by the claims, nor is it intended to be limiting as to the scope of the invention in any way.

I claim:

1. A drum shell with incorporated lugs comprising:
(a) three or more stacked wood laminate segments, wherein said laminate segments are configured such that every other one is rotated around a center point, then fastened together to form a sturdy stack;
(b) three or more integral drum shell lugs having centered openings, wherein said drum shell lugs have been machined from said fastened stacked laminate wood segments;
(c) threaded inserts located within said drum shell lug centered openings to accept oppositely threaded tensioning screws; and
(d) a bearing edge carved into the uppermost and lowermost stacked wood laminate wood segments to support the drum head.

2. The drum shell with incorporated lugs, according to claim 1, wherein said three or more stacked wood laminate segments are pentagon shaped, and are rotated 36 degrees from center.

3. The drum shell with incorporated lugs, according to claim 1, wherein said three or more stacked wood laminate segments are about 0.5 to 1.5 inches in height.

4. The drum shell with incorporated lugs, according to claim 3, wherein said three or more stacked wood laminate segments numbers 10, thereby creating a drum shell height of about 5 to 15 inches.

5. The drum shell with incorporated lugs, according to claim 1, wherein said three or more integral drum shell lugs having centered openings numbers about 8 to 12 or more drum shell lugs.

6. The drum shell with incorporated lugs, according to claim 1, wherein said drum shell includes integral machined routered grooves in place of integral machined drum shell lugs.

7. The drum shell with incorporated lugs, according to claim 6, wherein said drum shell lugs are not machined integral to the drum shell, but are tongue and groove drum shell lugs generated separately to be fitted to said drum shell having routered joints.

8. The drum shell with incorporated lugs, according to claim 1, wherein said threaded inserts located within said drum shell lug centered openings to accept oppositely threaded tensioning screws, are metal threaded inserts.

9. The drum shell with incorporated lugs, according to claim 1, wherein said three or more stacked wood laminates are comprised of decorative wood and finished to an aesthetically attractive grain and color.

10. A method for making a drum shell with incorporated lugs, comprising the steps of:
(a) providing three or more wood laminate segments;
(b) stacking said three or more wood laminate segments;
(c) rotating every other of said wood laminate segments around a center point;
(d) fastening each of said stacked and rotated wood laminate segments together with each adjoining segment;
(e) machining three or more drum shell lugs having a centered opening, directly from said fastened stack of wood laminates;
(f) installing a threaded insert into each of said drum shell lug centered openings; and
(g) finishing the drum shell to enhance the wood grain appearance.

11. The method for making a drum shell with incorporated lugs, according to claim 10, wherein said steps of providing, stacking and rotating said three or more wood laminate segments includes the steps of providing three or more stacked wood laminate segments that are pentagon shaped and are rotated 36 degrees from center.

12. The method for making a drum shell with incorporated lugs, according to claim 10, wherein said step of providing three or more wood laminate segments includes the step of providing three or more stacked wood laminate segments that are about 0.5 to 1.5 inches in height.

13. The method for making a drum shell with incorporated lugs, according to claim 12, wherein said step of providing three or more stacked wood laminate segments that are about 0.5 to 1.5 inches in height, further includes using 10 segments which generates a drum shell of about 5 inches to 15 inches in height.

14. The method for making a drum shell with incorporated lugs, according to claim 10, wherein said step of machining three or more drum shell lugs having a centered opening, directly from said fastened stack of wood laminates, further includes the step of machining about 8 to 12 or more drum shell lugs directly from said fastened stack of wood laminates.

15. The method for making a drum shell with incorporated lugs, according to claim 10, wherein said step of machining three or more drum shell lugs having a centered opening, directly from said fastened stack of wood laminates is deleted, and replaced by the step of:
machining integral routered grooves directly into said fastened stack of wood laminate segments.

16. The method for making a drum shell with incorporated lugs, according to claim 15, wherein said step of machining three or more drum shell lugs having a centered opening, directly from said fastened stack of wood laminates is deleted, and replaced by separately generating three or more drum shell lugs having a tongue and groove construction, to be fitted to said drum shell having routered grooves.

17. The method for making a drum shell with incorporated lugs, according to claim 10, wherein said step of installing a threaded insert into each of said drum shell lug centered openings, further includes the step of installing a metal threaded insert.

18. The method for making a drum shell with incorporated lugs, according to claim 17, wherein said step of installing a metal threaded insert further includes installing a steel or brass threaded insert.

19. The method for making a drum shell with incorporated lugs, according to claim 10, wherein said step of finishing the drum shell to enhance the wood grain appearance, further includes the step of varnishing the completed drum shell.

20. The method for making a drum shell with incorporated lugs, according to claim 10, wherein said step of finishing the drum shell to enhance the wood grain appearance, further includes the step of painting the completed drum shell.
